(19) United States
(12) Patent Application Publication
(10) Pub. No.: US 2018/0092357 A1
(43) Pub. Date: Apr. 5, 2018

(54) SYNERGISTIC PRESERVATIVE COMPOSITIONS

(71) Applicant: ISP Investments LLC, Wilmington, DE (US)

(72) Inventors: Raman PREMACHANDRAN, Saddle Brook, NJ (US); Najeeb H. HAKIMI, Edison, NJ (US); Kalpa MEHTA, Raritan, NJ (US); Karen WINKOWSKI, Springfield, NJ (US); Jennifer MUSYOKI, Prospect Park, NJ (US); Jyoti GUPTA, Basking Ridge, NJ (US)

(73) Assignee: ISP Investments LLC, Wilmington, DE (US)

(21) Appl. No.: 15/564,987

(22) PCT Filed: Apr. 7, 2016
(86) PCT No.: PCT/US16/26400

§ 371 Date: Oct. 6, 2017

Related U.S. Application Data
(60) Provisional application No. 62/145,310, filed on Apr. 9, 2015.

(51) Int. Cl. A01N 43/28; A01N 31/02; A01N 25/22; C11D 3/48; C11D 7/26; C11D 3/20

(52) U.S. Cl. CPC A01N 43/28; A01N 31/02; A01N 25/22; A01N 2300/00; C11D 7/267; C11D 3/2093; C11D 3/48

(57) ABSTRACT

What is described herein is a synergistic preservative composition capable of providing broad spectrum antimicrobial activity comprising: (i) about 0.1 wt. % to about 99.9 wt. % of propylene carbonate; (ii) about 0.1 wt. % to about 99.9 wt. % of one or more organic compounds, and wherein, inclusion of each additional organic compound is capable of demonstrating cumulative synergistic effect; and (iii) optionally about 0.1 wt. % to 99.0 wt. % of one or more preservative compounds, and wherein, inclusion of each preservative compound is capable of demonstrating cumulative synergistic effect, wherein the Synergy Index (SI) value of the total composition is from about 0.05 to about 0.95. Also described is a process for preparing said composition and method of use of the same.

### FIELD OF THE INVENTION

The present application relates to synergistic preservative compositions, and more particularly, to synergistic preservative compositions that are capable of providing broad spectrum antimicrobial activity comprising propylene carbonate, one or more organic compounds, and/or one or more preservative compounds, and wherein said propylene carbonate do not possess any antimicrobial activity.

### BACKGROUND OF THE INVENTION

The preservatives or preservative systems are employed in various non-limiting industrial applications including personal care, household, coatings, metalworking fluids, paper, wood, plastics, disinfection, cosmetics, toiletry, pharmaceuticals, food, beverages, oral care, paints, or water treatment to overcome the problems of mildew, mold, fungi, bacterial based microbial contamination.

Particularly, the personal care, pharmaceuticals, food, beverages, nutrition care products fragrance products, cosmeceuticals, nutraceuticals, cosmetics, treatment, skin care and anti-aging products usually incorporate ingredients that support microbial growth and proliferation, and therefore, these products engage significant amounts of preservatives as they directly affect the consumers. Additionally, regardless of their use, these products in general include aqueous medium as one important component. This aqueous phase facilitates a medium in which microorganisms can survive and/or proliferate. Thus, these products by their very nature create an environment and viable medium for the proliferation of microbial organisms. Without the addition of some preservative agent, these types of products are susceptible to microbial contamination and proliferation.

Accordingly, a preservative can be added to such products at the time of manufacturing in order to protect the product against microbial contamination in the long term. The particular choice of type and level of the preservative is typically made by the formulator based upon a number of factors including, for example, the microbiological requirements of the product, cost, the pH of the product, compatibility with the other formulation ingredients and regulatory restrictions. A guide to the factors used in preservative selection and testing can be found in “Cosmetic and Drug Preservation, Vol. I, Principles and Practice”, published by Marcel Dekker Inc.

In the recent past, the demand for natural consumer products is of great importance across the globe. Such products tend to comprise preservatives that are natural, green, organic, sustainable, bio-degradable, nature identical, eco-friendly, environmentally safe, preservative free, paraben free, alcohol free, capryl glycol free, phenoxyethanol free and non-toxic in nature. Such natural sector(s) has become one of the fastest growing in the North American personal care and cosmetics based industrial segments.

Further, according to current regulatory guidelines, the permitted use levels of conventional, traditional and progressive preservatives are not capable of preserving end-user products. However, such preservatives are capable of preserving the end-user products by inhibiting or killing the microbial strains at higher concentrations levels than recommended limits. Therefore, there is an absolute need to find a solution to make or empower such pre-existing conventional, traditional and progressive preservatives that can kill or inhibit microbial strains within permitted use levels.

Although some of these progressive preservatives are green but have inherent properties of not partitioning into the water phase to enhance preservative activity. Instead they connect or mix with the oil phase of the end-user products to modify their rheological properties in a negative way.

Accordingly, it is a primary objective of the present application is to find a solution to increase efficacy of conventional and progressive preservatives and thereby reduced or lower concentrations of such preservatives that can kill or inhibit the microbial strains. Accordingly, the lower concentrations of preservatives lead to reduced cost and minimized toxicity.

Another objective or the present application is to provide an efficacious preservative or preservative system that is compatible with end-user products and does not affect its physical and rheological properties during if integrated with them.

Yet another objective of the present application is provide an efficacious preservative or preservative system that can offer broad spectrum efficacy against gram (+), gram (−) bacteria, mold and yeast.

One other objective of the present application is to provide a solution to enhance the partitioning of poorly water soluble green progressive preservatives into the water phase when added to end-user products which comprise mixtures of oil and water based ingredients.

Still another objective of the present application is to provide an effective preservative or preservative system which is free from phenoxyethanol, capryl glycol, and/or alcohol.

U.S. Pat. No. 5,026,723A assigned to Katayama Chemical Works Co discloses a microbicidal/microbistatic composition for industrial use comprising (I) a nitrobromopropane derivative selected from the group consisting of: (a) 2-bromo-2-nitro-1,3-diacetyloxypropane, and (b) 2-bromo-2-nitro-1,3-diformyloxypropane; and (II) 4,5-dichloro-1,2-dithiol-3-one wherein (I) and (II) are present in a synergistic ratio of from 100:1 to 1:5 by weight, wherein, the hydrophilic organic solvent is selected from the group consisting of dimethylformamide, methyl acetate, ethyl acetate, propyl acetate, 3-methoxybutyl acetate, 2-ethoxymethyl acetate, 2-ethoxyethyl acetate and propylene carbonate.

WO1999006506A1 assigned to PAINTEX INT CORP discloses a non-toxic, non-irritating, non-flammable composition for cleaning surfaces, absent chlorinated solvents and having a low VOC comprising in combination: a synergistic combination of an anionic and/or nonionic poly alkoxylated surfactant and a lower poly alkylene glycol alkyl ether having a repeating unit containing 2-9 carbon atoms, wherein the aprotic solvent is selected from the group consisting of ethylene carbonate, propylene carbonate, dimethyl sulfoxide, N-methyl-2-pyrolidinone and butyrolactone.

U.S. Pat. No. 5,122,301A assigned to Great Lakes Chemical Corp. discloses an antimicrobial composition comprising an antimicrobial selected from the group consisting of bromonitrostyrene and bromonitroethenylfuran; and a carrier solvent selected from the group consisting of propylene carbonate, ethylene carbonate and mixtures thereof.

### SUMMARY OF THE INVENTION

The primary objective of the present application is to provide a synergistic preservative composition capable of providing broad spectrum antimicrobial activity comprising: (i) about 0.1 wt. % to about 99.9 wt. % of propylene carbonate; (ii) about 0.1 wt. % to about 99.9 wt. % of one or more organic compounds, and wherein, inclusion of each additional organic compound is capable of demonstrating cumulative synergistic effect; and (iii) about 0.1 wt. % to 99.0 wt. % of one or more preservative compounds, and wherein, inclusion of each preservative compound is capable of demonstrating cumulative synergistic effect, wherein the Synergy Index (SI) value of the total composition is from about 0.05 to about 1.0.

Another aspect of the present application provides synergistic preservative compositions capable of inhibiting or killing Candida tropicalis, Candida albicans, Hansenula anomala, Saccharomyces cerevisiae, Torulaspora delbreuckii, Zygosaccharomyces bailii, Zygosaccharomyces rouxii, Bacillus subtilis, Bacillus cereus, Staphylococcus aureus, Staphylococus epidermidis, Escherichia coli, Salmonella typhimurium, Salmonella enteritidis, Pseudomonas aeruginosa, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, Aspergillus brasiliensis, Burkhodelia cepacia, Enterobacter aerogenes, Enterobacter cloacae, Enterobacter gergoviae, Klebsiella pneumoniae, Proteus vulgaris, Pseudomonas fluorescens, Pseudomonas putida, Penicillium pinophilum and/or Mucor racemosus.

One other aspect of the present application provides synergistic preservative compositions employed in various aqueous and non-aqueous based end-user applications comprising cosmetic products, toiletry products, personal care products, oral care products, skin care products, hair care products, household & cleaning products, industrial and institutional cleaning products, disinfecting products, contact lens, enzyme based formulations, wound care, sanitary products, agricultural compositions, textile industries, coating industries and/or laundry products. The preservative composition can be delivered as emulsion, microemulsion, nanoemulsion, solution, dispersion, suspension, complex coacervates, lamellar based delivery systems, liposome/niosome formulations or concentrates.

Another important aspect of the present application provides a process for preparing the above-described synergistic preservative, wherein said process comprising mixing (i) about 0.1 wt. % to about 99.9 wt. % of propylene carbonate; (ii) about 0.1 wt. % to about 99.9 wt. % of one or more organic compounds selected from the group consisting of diols, C₁-C₂₀ alkane diols, glycerins, C₄-C₁₈ alkyl glycerins, esters of glycerins, organic acids and their sodium/potassium salts, C₁-C₂₀ fatty acids and their sodium/potassium salts, esters of organic acids, esters of C₁-C₂₀ fatty acids, waxes, terpenes, triglycerides, amino acids, protein acids, amino peptides, oligo peptides, essential oils, natural preservatives, herbal preservatives, and/or oils derived from natural products; and (iii) about 0.1 wt. % to 99.0 wt. % of one or more preservatives to provide homogenous solution.

According to yet another aspect of the present application, a method is provided of killing bacteria, fungi, molds, yeasts and viruses or inhibiting their growth in a cosmetic, personal care, house hold, cleaning, and/or Industrial & Institutional products those are susceptible to growth of microorganisms comprising incorporating into such product about 0.01 wt. % to 5.0 wt. % of said synergistic preservative composition.

### DETAILED DESCRIPTION OF THE INVENTION

While this specification concludes with claims particularly pointing out and distinctly claiming that which is regarded as the invention, it is anticipated that the invention can be more readily understood through reading the following detailed description of the invention and study of the included examples.

By the term “comprising” herein is meant that various optional, compatible components can be used in the compositions herein, provided that the important ingredients are present in the suitable form and concentrations. The term “comprising” thus encompasses and includes the more restrictive terms “consisting of” and “consisting essentially of” which can be used to characterize the essential ingredients such as propylene carbonates, aromatic compounds, solvents and/or conventional preservatives if any of the synergistic preservative composition.

All percentages, parts, proportions and ratios as used herein, are by weight of the total composition, unless otherwise specified. All such weights as they pertain to listed ingredients are based on the active level and, therefore; do not include solvents or by-products that may be included in commercially available materials, unless otherwise specified.

All references to singular characteristics or limitations of the present invention shall include the corresponding plural characteristic or limitation, and vice-versa, unless otherwise specified or clearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

As used herein, the words “preferred,” “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

References herein to “one embodiment,” “one aspect” or “one version” or “one objective” of the invention include one or more such embodiment, aspect, version or objective, unless the context clearly dictates otherwise.

All publications, articles, papers, patents, patent publications, and other references cited herein are hereby incorporated herein in their entireties for all purposes to the extent consistent with the disclosure herein.

The term “preservative” or “antimicrobial” as used herein is to be understood to refer to agents such as bactericides, fungicides, algicides, aquaticides, herbicide, insecticide, pesticide, plant growth regulators and the like, which are used for their ability to inhibit growth of and/or kill biological and/or microbiological species such as bacteria, fungi, algae, caterpillar, insects, larvae, mildew, rodents, spider, worm and the like.

The term ‘Preservation” refers to prevent or retard the any consumer products deterioration due to microbial attack. A preservative is an active ingredient that hinders or kills the growth of bacterial and fungal strains that can be present in any consumer products, and chiefly water based consumer products. Therefore, the preservative action of any consumer products is performed by employing a single preservative or mixture of preservatives to have broad spectrum antimicrobial activity.

The term “Broad Spectrum” as described herein means that the preservative compositions of the present application have ability to inhibit or kill wide range of microbial organisms which are responsible to decay or spoil any consumer products that are prone to microbial attack.

The term “additive effect” or “additive synergism” refers to the combined effect produced by the action of two or more compounds or two or more organic compounds having less preservative ability being equal to the sum of their separate effects of organic compounds or preservative compounds. The term “cumulative effect” or “cumulative synergism” refers to serial addition of said organic or preservative compounds results a synergistic effect which is several times greater than sum of their individual effects or additive effects.

As used, herein, “stable” and “stability” mean a composition which is significantly unaffected in chemical nature, physical homogeneity and/or color upon exposure to conditions reasonably expected to be incurred in transport, storage and their use in end-user applications. Stability may be determined either by empirical observation or by suitable methods of chemical and/or physical examination that would be known to one skilled in the art.

What is described herein is a synergistic preservative composition which is capable of providing broad spectrum antimicrobial activity comprising: (i) about 0.1 wt. % to about 99.9 wt. % of propylene carbonate; (ii) about 0.1 wt. % to about 99.9 wt. % of one or more organic compounds, and wherein, inclusion of each additional organic compound is capable of demonstrating cumulative synergistic effect; and (iii) optionally about 0.1 wt. % to 99.0 wt. % of one or more preservative compounds, and wherein, inclusion of each preservative compound is capable of demonstrating cumulative synergistic effect. The Synergy Index (SI) value of the total composition is from about 0.05 to about 1.0, and other ranges of Synergy Index would include, but are not limited to, about 0.05 to 0.1, about 0.1 to about 0.2, about 0.2 to 0.3, about 0.3 to 0.4, about 0.4 to 0.5, about 0.5 to 0.6, about 0.6 to 0.7, about 0.7 to 0.8, about 0.8 to 0.9, and about 0.9 to 0.95.

According to one important aspect of the present application, the synergistic preservative composition can be totally free from phenoxyethanol, alcohol and/or capryl glycol. According to additional aspect of the present application, the synergistic preservative composition includes phenoxyethanol, alcohol and/or capryl glycol. Further, the present composition can be an alternative preservative or preservative system to replace the phenoxyethanol, alcohol and/or capryl glycol.

According to another aspect of the present application, the synergistic composition of the present application is capable of providing cumulative synergistic effect than additive synergistic effect, wherein said cumulative synergy increases the efficacy of the total composition and reduces the required approved antimicrobial use levels of (i) one or more organic compounds and/or (ii) one or more preservative compounds.

According to another aspect of the present application, the inclusion of propylene carbonate to (i) one or more organic compound/s and/or (ii) one or more preservative compound/s provides an effective composition capable of demonstrating cumulative synergism. The use of propylene carbonate increases the efficacy of the cumulative synergistic composition and thereby further reduces the use levels of required organic compounds or preservative compounds. The reduction in use or required level of organic compounds/preservative compounds is extremely significant in nature.

The amount of propylene carbonate employed in the present application includes but is not limited to about 0.1 wt. % to about 10 wt. %, about 11 wt. % to about 20 wt. %, about 21 wt. % to about 30 wt. %, about 31 wt. % to about 40 wt. %, about 41 wt. % to about 50 wt. %, about 51 wt. % to about 60 wt. %, about 61 wt. % to about 70 wt. %, about 71 wt. % to about 80 wt. %, about 81 wt. % to about 90 wt. %, about 91 wt. % to about 99.9 wt. %.

According to one important embodiment of the present application, the presence propylene carbonate capable of reducing yellowing effect of preservative compound or organic compounds that are susceptible for yellowing either alone or when added to end-user products.

According to another embodiment of the present application, the ratio of organic compounds and preservative compounds to propylene carbonate is optimized to provide antimicrobial action which is synergistically intensified. The ratio of propylene carbonate to organic/preservative compounds preferably is in the range of from about 1:10 to about 10:1.

In one embodiment of the application, the synergistic composition of propylene carbonate with organic compounds or preservative compounds is capable of providing broad spectrum antimicrobial properties. Propylene carbonate has no significant antimicrobial and antifungal characteristics (MIC). However, the propylene carbonate boosts significantly both the antimicrobial and antifungal characteristics of known preservatives or boosters. The presence of propylene carbonate in the composition has the ability to maximize the partitioning of the mixture of organic/preservative compounds into the water phase when added to an end-user composition comprising a mixture of oil and a water phase. Further, the propylene carbonate based compositions or blends acts as delivery agent for other preservative/organic actives that have low polarity with high dielectric constant making it a suitable blend to dissolve hydrophobic non polar actives, the high dielectric constant of the composition enable them to partition the active towards the oil/water interface which is critical for maximum efficacy and reduced use levels of preservatives or boosters.

One or more organic compounds for the purposes of present application is duly selected based on their ability to demonstrate cumulative synergy or cumulative effect when two or more organic compounds are combined together, and wherein, the desired Synergy Index (SI) for selecting such two or more organic compounds falls in the range of from about 0.05 to about 1.0 approximately. Other suitable SI ranges for selecting two or more organic compounds is from about 0.05 to about 0.95, and other ranges of Synergy Index would include but not limited to about 0.05 to 0.1, about 0.1 to about 0.2, about 0.2 to 0.3, about 0.3 to 0.4, about 0.4 to 0.5, about 0.5 to 0.6, about 0.6 to 0.7, about 0.7 to 0.8, about 0.8 to 0.9, and about 0.9 to 0.95. The synergy test is performed with one individual microorganism and based on their efficacy, the components of the composition is selected to target particular bacterial or fungal strains of interest.

Similarly, one or more organic compounds for the present application is appropriately selected based on their ability to demonstrate cumulative synergy or cumulative effect when two or more preservative agents are combined together, and wherein, the desired Synergy Index (SI) for selecting such two or more preservative compounds falls in the range of from about 0.05 to about 1.0 approximately. Other suitable SI ranges for selecting two or more preservative compounds is from about 0.05 to about 1.0, and other ranges of Synergy Index would include but not limited to about 0.05 to 0.1, about 0.1 to about 0.2, about 0.2 to 0.3, about 0.3 to 0.4, about 0.4 to 0.5, about 0.5 to 0.6, about 0.6 to 0.7, about 0.7 to 0.8, about 0.8 to 0.9, and about 0.9 to 0.95.

Another non-limiting embodiment of the present application provides a suitable organic compound for preparing the synergistic composition of the present application duly selected from the group consisting of, but not limited to, diols, C₂-C₂₀ alkane diols, glycerins, C₄-C₁₈ alkyl glycerins, esters of glycerins, organic acids and their sodium/potassium salts, C₂-C₂₀ fatty acids and their sodium/potassium salts, esters of organic acids, esters of C₂-C₂₀ fatty acids, waxes, terpenes, triglycerides, protein acids, amino peptides, oligo peptides, aromatic aldehydes, glucosides, alkyl glucosides, enzymes, peptides/amino acid and their esters, essential oils, natural preservatives, herbal preservatives, and/or oils derived from natural products.

In accordance with another embodiment of the present application, the amount of organic compounds employed in the present application includes, but is not limited to, about 0.1 wt. % to about 10 wt. %, about 11 wt. % to about 20 wt. %, about 21 wt. % to about 30 wt. %, about 31 wt. % to about 40 wt. %, about 41 wt. % to about 50 wt. %, about 51 wt. % to about 60 wt. %, about 61 wt. % to about 70 wt. %, about 71 wt. % to about 80 wt. %, about 81 wt. % to about 90 wt. %, about 91 wt. % to about 99.9 wt. %.

An alkanediol based organic compounds can be employed in the present application containing at least two carbon atoms, and wherein, any two hydrogen atoms of a saturated aliphatic hydrocarbon of the alkanediol compound are substituted with hydroxyl groups, and wherein, the presence hydroxy groups, (—OH) of the alkanediol may be primary, secondary, or tertiary. In one embodiment, the presence of two hydroxyl functional groups can be adjacent to each other (vicinal), or can be present in their terminal position as —OH groups or randomly present in any two carbon atom of the carbon chain of C₂₋₂₀. The structure I represents the desired alkanediols of the present application, and wherein, R₁, R₂, R₃, R₄ are independently hydrogen, C₁₋₂₀ alkyl/cycloalkyl, C₁₋₂₀ substituted alkyl/cycloalkyl, hydrocarbyl functional groups. Further, “A” can be a direct bond, independently hydrogen, C₁₋₂₀ alkyl/cycloalkyl, C₁₋₂₀ substituted alkyl/cycloalkyl, and hydrocarbyl functional groups. The term “hydrocarbyl” refers to substituted or unsubstituted alkyl, alkenyl, cycloalkyl, cycloalkenyl or aralkyl, mono-, di- or poly-functional radical that may further contain one or more hetero atoms,

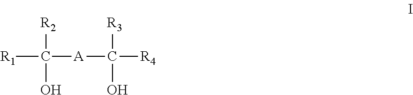

In one important embodiment of the present application, the preferable —OH positions are 1,2, and 1,3 i.e. 1,2-alkane diols and 1,3 alkane diols. The representative structures of alkanediols are in accordance with structure Ia and Ib (1, 2, —OH and 1, 3 —OH positions) and Ic (terminal —OH position), and wherein R denotes a hydrogen, cycloalkyl/alkyl groups having 2 to 20 carbon atoms.

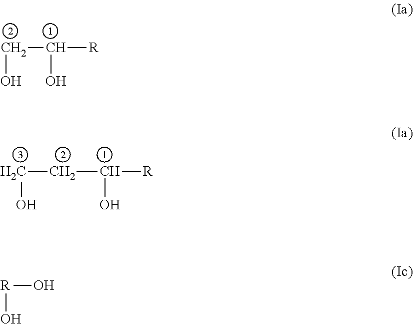

Other, non-limiting examples of the alkanediol compounds having —OH groups at adjacent or different positions include, but are not limited to, 1,2-propanediol, 1,3-propanediol, 1,2-butanediol, 1,3-butanediol, 1,4-butanediol, 1,5-pentanediol, 1,6-hexanediol, 1,7-heptanediol, 1,8-octanediol, 1,9-nonanediol, 1,10-decanediol, neopentyl glycol, isoprene glycol (3-methyl-1,3-butanediol), 1,2-hexanediol, 1,6-hexanediol, 3-methyl-1,5-pentanediol, 1,2-octanediol, 2,3-octanediol, 2-ethyl-1,3-hexanediol, 2-butyl-2-ethyl-1,3-propanediol, 2,5-dimethyl-2,5-hexanediol, 1,2-decanediol, 1,2-dodecanediol, 1,2-tetradecanediol, 1,2-hexadecanediol, 1,2-octadecanediol, 1,12-octadecanediol, 1,2-cyclohexanediol, 1,4-cyclohexanediol, and 1,4-cyclohexanedimethanol. The preferred diols for the present application is selected from group consisting of 1,3-propanediol, 1,2-hexanediol, 1,2-octanediol, and/or 1,2-decanediol.

According to another embodiment of the present application, it is contemplated to employ at least one alkanediol ester or glycol ester as an organic compound to prepare a synergistic preservative composition. The representative glycol esters or alkanediol esters would fall into generic structure of IIa and IIb, and wherein, R is cycloalkyl or alkyl groups having 2 to 20 carbon atoms, and R₁ and R₂ each independently a hydrogen, an alkyl, a cycloalkyl groups having 2 to 20 carbon atoms.

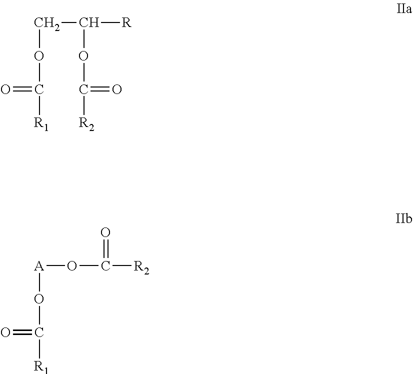

Further, it is contemplated to employ vicinal alkanediol compounds that have at least two hydroxyl groups on adjacent carbon atoms are contemplated to employ as preferred alkanediol compounds for the present application. Also it is considered to employ monoester and di-ester of vicinal alkanediol compounds as an organic compound, and wherein the vicinal alkanediol compounds have a generic structure of (IIIa), and mono or di-ester of vicinal alkanediols have a generic structure of (IIIb), wherein R denotes an alkyl or cycloalkyl group having 2 to 20 carbon atoms, and R₁ and R₂ is a hydrogen, an alkyl or cycloalkyl functional group having 2 to 20 carbon atoms.

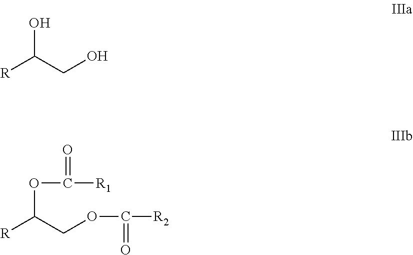

Examples of the alkyl group include a butyl group, an isobutyl group, a secondary butyl group, a tertiary butyl group, a pentyl group, an isopentyl group, a secondary pentyl group, a neopentyl group, a tertiary pentyl group, a hexyl group, a secondary hexyl group, a heptyl group, a secondary heptyl group, an octyl group, a secondary octyl group, a nonyl group, a secondary nonyl group, a decyl group, a secondary decyl group, an undecyl group, a secondary undecyl group, a dodecyl group, a secondary dodecyl group, a tridecyl group, an isotridecyl group, a secondary tridecyl group, a tetradecyl group, a secondary tetradecyl group, a hexadecyl group, a secondary hexadecyl group, a stearyl group, a 2-ethylhexyl group, a 2-butyloctyl group, a 2-butyldecyl group, and a 2-hexyloctyl group.

The term glycerols or glycerins are used interchangeably in the entire application, and the suitable glycerins or glycerols for the present application would include but not limited to alkyl glycerols, glycerol esters, alkyl/aryl substituted glycerols, alkyl/aryl substituted glycerol esters. The alkyl glycerols are particularly selected from structure (IV) and wherein, R₁, R₂ and R₃ are each independently a hydrogen, an alkyl group, an aryl group, a cycloalkyl group, a cycloaryl group or combinations thereof having a carbon atoms of C₁-C₁₈, and in particular, C₂-C₈. However, the non-limiting category of alkyl glycerol would include 1-alkyl glycerols, 2-alkyl glycerols, or 3-alkyl glycerols, 1,2-dialkyl glycerols, 1,3-dialkyl glycerols, 2,3-dialkyl glycerols, and/or 1,2,3-trialkyl glycerols. Similarly, the esters of glycerols can be mono, di or tri ester of glycerols or their alkyl derivatives are selected from the generic structures of III-IX, and wherein, A₁, A₂ or A₃ are each independently a C₂ to C₂₄ linear or branched fatty acid residue containing zero to three double bonds, wherein R₁ can be each independently a hydrogen, C₁-C₂₀ alkyl, an aryl, C₁-C₂₀ cycloalkyl, cycloaryl substituted and combinations thereof.

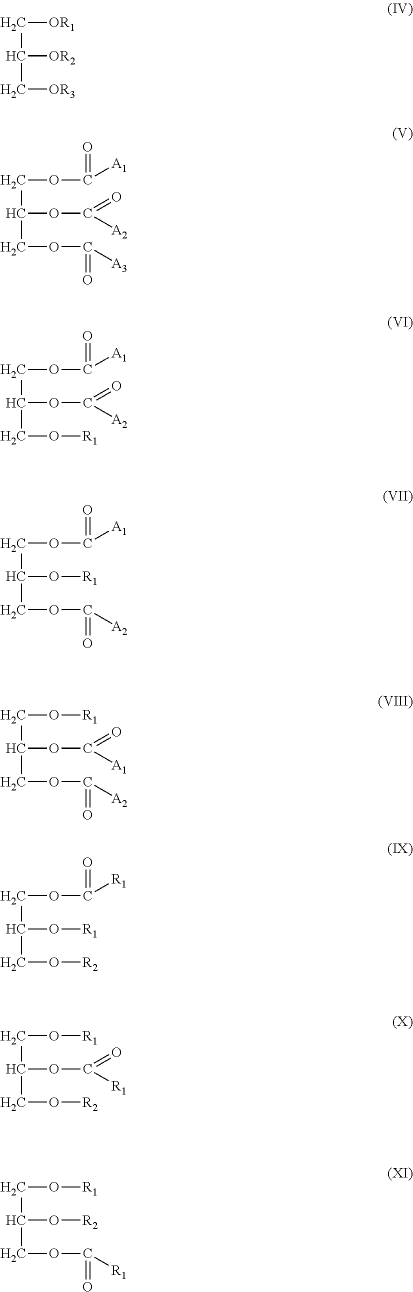

Suitable organic acids are selected from the group consisting of sugar acids, α-hydroxy carboxylic acids, β-hydroxy carboxylic acids, α-hydroxy organic acids and/or β-hydroxy organic acids. Non-limiting organic acid include benzoic acid, salicylic acid, benzoic acid, glycolic acid, succinic acid, lactic acid, malic acid, citric acid, octanoic acid, 2-hydroxyalkanoic acids, 2-hydroxyalkenoic acid, 2-hydroxy-n-butanoic acid, 2-hydroxy-n-hexanoic acid, 2-hydroxy-n-octanoic acid, 2-hydroxy-n-decanoic acid, 2-hydroxy-n-dodecanoic acid, 2-hydroxy-n-tetradecanoic acid, 2-hydroxy-n-hexadecanoic acid, 2-hydroxy-4-hexenoic acid, 2-hydroxy-4-octenoic acid, 2-hydroxy-4-decenoic acid, 2-hydroxy-4-dodecenoic acid, 2-hydroxy-4-tetradecenoic acid, 2-hydroxy-4-hexadecenoic acid, 2-hydroxy-4,7-octadienoic acid, 2-hydroxy-4,9-decadienoic acid, 2-hydroxy-4,10-undecadienoic acid, 2-hydroxy-4,11-dodecadienoic acid, 2-hydroxy-4,13-tetradecadienoic acid, 2-hydroxy-4,15-hexadecadienoic acid, 2-hydroxy-6-oxa-4-heptenoic acid, 2-hydroxy-7-oxa-4-octenoic acid, 2-hydroxy-9-oxa-4-decenoic acid, 2-hydroxy-9-oxa-4-undecenoic acid, 2-hydroxy-11-oxa-4-dodecenoic acid, 2-hydroxy-13-oxa-4-tetradecenoic acid, 2-hydroxy-13-oxa-4-pentadecenoic acid, 2-hydroxy-14-oxa-4-pentadecenoic acid, 2-hydroxy-13-oxa-14-methyl-4-pentadecenoic acid, 2-hydroxy-11,14-dioxa-4-pentadecenoic acid, 2-hydroxy-13-oxa-4-hexadecenoic acid, 2-hydroxy-14-oxa-4-hexadecenoic acid, 2-hydroxy-15-oxa-4-hexadecenoic acid.

In a preferred embodiment of the present application, the organic acids can be at least one saturated/unsaturated fatty acids, at least one saturated/unsaturated fatty acid esters, at least one C₁-C₂₀ alkyl/cycloalkyl substituted saturated/unsaturated fatty acids, at least one C₁-C₂₀ alkyl/cycloalkyl substituted saturated/unsaturated fatty acid esters, alone or in combination thereof, wherein the desired fatty acids and fatty acid ester will have carbon chain length of from about 2 to 20. In one embodiment non-limiting examples of saturated/unsaturated fatty acid and their ester would comprise adipic, caprylic acid, capric acid, lauric acid, myristic acid, myristoleic acid, palmitic acid, palmitoleic acid, stearic acid, oleic acid, ricinoleic acid, linoleic acid, linolenic acid, eleostearic acid, arachidic acid, arachidonic acid, behenic acid, erucic acid, γ-linolenic acid, homo-γ-linolenic acid, columbinic acid, eicosa-(n-6,9,13)-trienoic acid, arachidonic acid, α-linolenic acid, timnodonic acid, hexaenoic acid, lignoceric acid, cerotic acid, sapienic acid, elaidic acid, vaccenic acid, linoelaidic acid, α-linolenic acid, eicosapentaenoic acid, docosahexaenoic acid alone or in combination thereof.

Triglyceride is an ester derived from glycerol and three fatty acids such fatty acids for preparing desired triglycerides can be selected from the above described list of fatty acids of saturated and unsaturated nature. However, the preferred triglycerides of interest can be caprylic triglycerides, capric triglyceride, isostearic triglyceride, adipic triglyceride, cholesteiyl oleate, glyceryle triheptanoate, glycerine trioctanoate alone or in combination thereof. Further, mono and di glycerides can also be employed as organic compounds using said saturated and unsaturated fatty acids.

Suitable oils that can be employed as preferred organic compound for the present application include, but are not limited to, angelica oil, ylang ylang oil, elemi oil, German chamomile oil, anthemis nobilis oil, cardamom oil, calamus oil, galbanum oil, camphor oil, carrot seed oil, clary sage oil, clove oil, cinnamon bark oil, coriander oil, cypress oil, sandalwood oil, cedarwood oil, citronella oil, cinnamon leaf oil, jasmine absolute, juniper berry oil, ginger extract, spearmint oil, sage oil, cedar oil, geranium oil, thyme oil, tea tree oil, nutmeg oil, niaouli oil, neroli oil, pine oil, basil oil, peppermint oil, patchouli oil, palmarosa oil, fennel oil, petitgrain oil, black pepper oil, frankincense oil, vetiver oil, peppermint oil, bergamot oil, benzoin oil, aniba rosaeodora oil, marjoram oil, myrrh oil, melissa oil, eucalyptus oil, ravensara oil, lavandin oil, lavender oil, lindane oil, rose oil, rosewood oil, rosemary oil and lovage oil.

Suitable amino acids and peptides contemplated to employ for the present application include, but are not imited to, glycine, valine, leucine, isoleucine, serine, threonine, phenylalanine, tyrosin, tryptophan, cystine, cysteine, methionine, hydroxyproline, aspartic acid, asparagine, glutamic acid, glutamine, histidine, lysine, alanine, arginine, glutamic acid, glutamine, γ-aminobutyric acid, DL-pyrrolidonecarboxylic acid and ∈-aminocaproic acid. The peptides can be di, tri, tetra, penta, hexa, hepta, octa, nona, deca, undeca, and/or icosa. Other peptides are hydrolyzed elastin, water-soluble elastin, hydrolyzed collagen, water-soluble collagen, casein, glutathione, wheat peptide and soybean peptide.

Terpenes are very large group of chemical substances that occur in nature as secondary ingredients from organisms. They are derived from two/three isoprene units that are known as monoterpenes and sesqui/di terpenes respectively. Suitable terpenes and/or terpenoids consist of mono-, sesqui- and diterpenes, menthol, citronellol, geraniol, nerolidol, linalool and terpineol, borneol, thujol, sabinol, myrtenol, thymol, verbenol, fenchol, piperitol, perillaaldehyde, phellandral, citronellal, citral, myrtenal, menthone, piperitone, pulegone, carvone, thujone, umbellulone, verbenone, chrysanthenone, fenchone, camphor, cineole, menthofuran, linalooloxide, rose oxide, or peroxides such ascaridole or artemisinin, hydroxycitronellal, hexylcinnamal, linaylacetate, alpha-isomethylionone, ethyl linalool, and hydroxyisohexyl 3-cyclohexene carboxaldehyde.

According to one important embodiment of the present application, the synergistic preservative composition comprises: (i) propylene carbonate; (ii) one or more organic compounds and additionally one or more preservative compounds. Non-limiting examples of additional preservatives employed are selected from the group consisting of triclosan, 2-methyl-4-isothiazolin-3-one (MIT), 1,2-benzisothiazolin-3-one (BIT), 5-chloro-2-methyl-4-isothiazolin-3-one (CMIT), 2-octyl-4-isothiazolin-3-one (OIT), 3-iodo-2-propynylbutyl-carbamate (IPBC), 3-iodopropynyl-N-phenyl carbamate (IPPC), zinc pyrithione (ZnPy), bronopol, quaternary ammonium compounds, parabens, alkyl parabens, chlorophenisin, benzyl alcohol, organic acids, sorbic acid and their salts, benzoic acid and their salts, salicylic and their salts, potassium sorbate, sodium benzoate, phenoxyethanol, diazolidinyl urea, imidazolidinyl urea, sodium hydroxymethyl glycinate, hydantoins, sodium pyrithione, phenyl ethanol, phenyl propanol, benzalkonium quaternary ammonium compounds, benzethonium chloride (BZT), dequalinium chloride, fatty acids and their salts, α-hydroxy acids and their salts, beta acids and their salts, glycerols, hexyl glycerine, tropolones, sisquiterpenes, chlorhexidine, polyhexamethylene biguanide, cetrimide, ehloroeresol, chlorxylenol, benzyl alcohol, bronopol, chlorbutanol, phenylethyl alcohol, formaldehyde releasing compounds, phenolic compounds, 2,4-dichlorobenzyl alcohol, thiomersal and/or ethyl hexyl glycerine.

Other non-limiting embodiments of the present application employ herbal extracts or mixture of herbal extracts as a preservative or preservative system, and wherein, specific herbal extracts include, but are not limited to, extracts of chamomile, rosemary, aloe, nettle, centella asiatica, ginkgo biloba, betula, witch hazel, green tea, flavonoids (quercetin, naringenin, naringin, hesperidin) extracts, white tea, grape skin, grape seed, grapefruit, grapefruit seed, grapefruit peel, citrus fruits (other than grapefruit extract) bilberry, blueberry, Ginkgo biloba, soy isoflavones, soy extract, fermented soy protein, black cohosh, St. John's wort, echinacea, chamomile, rosemary, aloe extract and juice, nettle, coconut fruit and centella asiatica.

In accordance with another embodiment of the present application, the amount of addition preservatives employed in the present application includes, but is not limited to, about 0.1 wt. % to about 10 wt. %, about 11 wt. % to about 20 wt. %, about 21 wt. % to about 30 wt. %, about 31 wt. % to about 40 wt. %, about 41 wt. % to about 50 wt. %, about 51 wt. % to about 60 wt. %, about 61 wt. % to about 70 wt. %, about 71 wt. % to about 80 wt. %, about 81 wt. % to about 90 wt. %, about 91 wt. % to about 99.9 wt. % of at least one preservative selected from the above.

Preferred synergistic preservative compositions include
I. (a) propylene carbonate with (b) octanediol/decanediol/hexanediol; or
II. (a) propylene carbonate with (b) hexylglycerin/cyclohexyl glycerin; or
III. (a) a mixture of propylene carbonate and hexylglycerin/cyclohexyl glycerin with (b) octanediol/decanediol/hexanediol; or
IV. (a) a mixture of propylene carbonate and octanediol/decanediol/hexanediol with (b) hexylglycerin/cyclohexyl glycerins; or
V. (a) a mixture of propylene carbonate, octanediol, decanediol, water, salicylaldehyde, and undecanal; or
VI. (a) a mixture of propylene carbonate and cyclohexylglycerin/hexanediol/octanediol with (b) sorbic acid and their alkali metal salts, salicylic acid and their alkali metal salts, or octanoic acid and their alkali metal salts.

The synergistic preservative composition of the present application is capable of inhibiting or killing yeasts, mold spores, gram (+), gram (−) bacterial strains, acne causing strains, odor causing strains, or mycoses causing strains, and wherein, the compositions can inhibit or retard or kill Candida tropicalis, Candida albicans, Hansenula anomala, Saccharomyces cerevisiae, Torulaspora delbreuckii, Zygosaccharomyces bailii, Zygosaccharomyces rouxii, Bacillus subtilis, Bacillus cereus, Staphylococcus aureus, Staphylococus epidermidis, Escherichia coli, Salmonella typhimurium, Salmonella enteritidis, Pseudomonas aeruginosa, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, Aspergillus brasiliensis, Burkhodelia cepacia, Enterobacter aerogenes, Enterobacter cloacae, Enterobacter gergoviae, Klebsiella pneumoniae, Proteus vulgaris, Pseudomonas fluorescens, Pseudomonas putida, Penicillium pinophilum and/or Mucor racemosus.

According to another embodiment of the present application, the synergistic combination of organic compounds or synergistic combination of preservative compounds are identified according to their ability or selectivity to kill or inhibit the specific microbial organisms. Such selectivity is identified based on series of experiments that can readily be carried out by the skilled artisan.

Preservative composition of present application is stable on storage for at least 2 years at room temperature. Further, the composition is capable of withstanding heat and cold exposure, wherein the composition is stable for at least 5 freeze/thaw cycles when the temperature is cycled from 50° C. to −24° C. in every 24 hours or stable for at least 4 weeks at about 50° C.

The synergistic preservative compositions can be aqueous or non-aqueous in nature, and they can be delivered through different formulations technique that are known in the prior art, wherein the non-limiting exemplary formulations would include emulsion, microemulsion, nanoemulsion, solution, dispersion, suspension, complex coacervates, lamellar based delivery systems, liposome/niosome formulations, or concentrate.

Such formulated synergistic preservative composition comprising propylene carbonate, organic compound and preservative can be used in various end-user based consumer applications, particularly in cosmetic products, toiletry products, personal care products, oral care products, skin care products, hair care products, household & cleaning products, soap and bath products, industrial and institutional cleaning products, disinfecting products, wound care, sanitary products, agricultural compositions, textile industries, coating industries and/or laundry products. The amount of preservative composition employed in aqueous and non-aqueous based end-user products/compositions is in the range of from about 0.01 wt. % to about 1.0 wt. % of the total composition. Other ranges include about 1.0 wt. % to about 2.0 wt. %, about 2.0 wt. % to about 3.0 wt. %, about 3.0 wt. % to about 4.0 wt. %, about 4.0 wt. % to about 5.0 wt. %.

One important embodiment of the present application relate to a process for preparing the above-described synergistic preservative composition, wherein said process comprising mixing (i) about 0.1 wt. % to about 99.9 wt. % of propylene carbonate; (ii) about 0.1 wt. % to about 99.9 wt. % of one or more organic compounds selected from the group consisting of diols, C₂-C₂₀ alkane diols, glycerins, C₄-C₁₈ alkyl glycerins, esters of glycerins, organic acids and their sodium/potassium salts, C₂-C₂₀ fatty acids and their sodium/potassium salts, esters of organic acids, esters of C₂-C₂₀ fatty acids, waxes, terpenes, triglycerides, amino acids, protein acids, amino peptides, oligo peptides, essential oils, natural preservatives, herbal preservatives, and/or oils derived from natural products; and (iii) optionally, about 0.1 wt. % to 99.0 wt. % of one or more preservatives to provide homogenous solution.

In one embodiment of the present application there is provided a synergistic preservative composition capable of providing broad spectrum antimicrobial activity comprising: (i) about 0.1 wt. % to about 99.9 wt. % of propylene carbonate; (ii) about 0.1 wt. % to about 99.9 wt. % one or more organic compounds selected from the group consisting of diols, alkane diols, glycerins, alkyl glycerins, esters of glycerins, organic acids and their salts, fatty acids and their salts, and/or esters of long chain fatty acids; and (iii) optionally, about 0.1 wt. % to 20.0 wt. % of one or more preservatives.

Another embodiment of the present application provides a synergistic preservative composition capable of providing broad spectrum antimicrobial activity comprising: (i) about 0.1 wt. % to about 99.9 wt. % of propylene carbonate; (ii) about 0.1 wt. % to about 99.9 wt. % of one or more organic compounds selected from the group consisting of propanediol, hexanediol, octanediol, decanediol, hexylglycerin, cyclohexylglycerin, glyceryl mono-di caprylate, propylene mono-di caprylate, octanoic acid and its sodium salts, methyl propane diol, glyceryl caprylate, propylene glycol monoheptanoate, glycerol monolaurate; and (iii) optionally, about 0.1 wt. % to 20.0 wt. % of one or more preservative is selected from the group consisting of salicylic acid, sodium salicylate, sorbic acid, potassium sorbate, dehydroacetic acid (DHA), benzoic acid, sodium benzoate, cinnamaldehyde, benzaldehyde, n-undecanol, and/or cetrimonium chloride.

Yet another embodiment of the present application provides a cosmetic or personal care or house hold, cleaning, Industrial & Institutional product comprising synergistic preservative composition comprising (i) about 0.1 wt. % to about 99.9 wt. % of propylene carbonate; (ii) about 0.1 wt. % to about 99.9 wt. % of one or more organic compounds, and wherein, inclusion of each additional organic compound is capable of demonstrating cumulative synergistic effect; and (iii) optionally, about 0.1 wt. % to 99.0 wt. % of one or more preservative compounds, and wherein, inclusion of each preservative compound is capable of demonstrating cumulative synergistic effect, wherein the Synergy Index (SI) value of the total composition is from about 0.05 to about 1.0. The amount of said preservative composition present in the cosmetic or personal care or house hold, cleaning, Industrial & Institutional products is in the range of from about 0.01 wt. % to 5.0 wt. %, relative to the total mass of said products.

Still another embodiment of the present application discloses a method of killing bacteria, fungi, molds, yeasts and viruses or inhibiting their growth in a cosmetic, personal care, house hold, cleaning, and/or Industrial & Institutional products those are susceptible to growth of microorganisms comprising incorporating into said products, about 0.01 wt. % to 5.0 wt. % of preservative composition of present application.

Further, certain aspects of the present invention are illustrated in detail by way of the following examples. The examples are given herein for illustration of the invention and are not intended to be limiting thereof.

### Example 1

| S. No | Ingredients | wt. % |
|---|---|---|
| 1 | Propylene Carbonate | 60.00 |
| 2 | 1,2-Hexanediol | 40.00 |
| | Total | 100.00 |

### Example 2

| S. No | Ingredients | wt. % |
|---|---|---|
| 1 | Propylene Carbonate | 55.00 |
| 2 | 1,2-Octanediol | 45.00 |
| | Total | 100.00 |

### Example 3

| S. No | Ingredients | wt. % |
|---|---|---|
| 1 | Propylene Carbonate | 60.00 |
| 2 | Cyclohexyl Glycerin | 40.00 |
| | Total | 100.00 |

### Example 4

| S. No | Ingredients | wt. % |
|---|---|---|
| 1 | Propylene Carbonate | 60.00 |
| 2 | 1,2-Hexanediol | 35.00 |
| 3 | 1,2 Decanediol | 5.00 |
| | Total | 100.00 |

### Example 5

| S. No | Ingredients | wt. % |
|---|---|---|
| 1 | Propylene Carbonate | 62.00 |
| 2 | 1,2-Octanediol | 30.00 |
| 3 | 1,2 Decanediol | 8.00 |
| | Total | 100.00 |

### Example 6

| S. No | Ingredients | wt. % |
|---|---|---|
| 1 | Propylene Carbonate | 45.00 |
| 2 | 1,2-Octanediol | 25.00 |
| 3 | 1,2 Hexanediol | 30.00 |
| | Total | 100.00 |

### Example 7

| S. No | Ingredients | wt. % |
|---|---|---|
| 1 | Propylene Carbonate | 42.00 |
| 2 | 1,2-Octanediol | 20.00 |
| 3 | 1,2 Hexanediol | 23.00 |
| 4 | 1,2-Decanediol | 7.00 |
| 5 | Water | 8.00 |
| | Total | 100.00 |

### Example 8

| S. No | Ingredients | wt. % |
|---|---|---|
| 1 | Propylene Carbonate | 40.00 |
| 2 | 1,2-Octanediol | 17.00 |
| 3 | 1,2 Hexanediol | 20.00 |
| 4 | 1,3 Propanediol | 15.00 |
| 5 | Water | 8.00 |
| | Total | 100.00 |

### Example 9

| S. No | Ingredients | wt. % |
|---|---|---|
| 1 | Propylene Carbonate | 30.00 |
| 2 | Propylene Glycol | 20.00 |
| | Monoheptanoate | |
| 3 | 1,2 Hexanediol | 20.00 |
| 4 | 1,3 Propanediol | 15.00 |
| 5 | Water | 15.00 |
| | Total | 100.00 |

### Example 10

| S. No | Ingredients | wt. % |
|---|---|---|
| 1 | Propylene Carbonate | 38.00 |
| 2 | 1,2-Octanediol | 25.00 |
| 3 | 1,2 Hexanediol | 11.00 |
| 4 | 1,3 Propanediol | 10.00 |
| 5 | 1,2-Decanediol | 7.00 |
| 6 | Water | 9.00 |
| | Total | 100.00 |

### Example 11

| S. No | Ingredients | wt. % |
|---|---|---|
| 1 | Water | 9.00 |
| 2 | Propylene Carbonate | 38.00 |
| 3 | 1,3 Propanediol | 10.00 |
| 4 | 1,2-Octanediol | 25.00 |
| 5 | 1,2 Hexanediol | 11.00 |
| 6 | 1,2 Decanediol | 7.00 |
| | Total | 100.00 |

### Example 12

| S. No | Ingredients | wt. % |
|---|---|---|
| 1 | Water | 20.00 |
| 2 | Propylene Carbonate | 15.00 |
| 3 | 1,3 Propanediol | 15.00 |
| 4 | 1,2 Hexanediol | 20.00 |
| 5 | Glyceryl Mono/Di Caprylate; | 20.00 |
| | Propylene Mono/Di Caprylate | |
| 6 | 1,2 Decanediol | 10.00 |
| | Total | 100.00 |

### Example 13

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Sorbic Acid/K Sorbate | 10.00 |
| | Total | 100.00 |

### Example 14

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Salicylic acid/Na Salicylate | 10.00 |
| | Total | 100.00 |

### Example 15

| S. No | Ingredients | wt. % |
|---|---|---|
| 1 | Water | 8.25 |
| 2 | Propylene Carbonate | 36.00 |
| 3 | 1,3 Propanediol | 9.50 |
| 4 | 1,2-Octanediol | 23.75 |
| 5 | 1,2 Hexanediol | 10.50 |
| 6 | 1,2 Decanediol | 6.75 |
| 7 | Dehydroacetic Acid | 5.25 |
| | Total | 100.00 |

### Example 16

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Benzoic acid/Na Benzoate | 10.00 |
| | Total | 100.00 |

### Example 17

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Octanoic Acid/Na Octanoate | 10.00 |
| | Total | 100.00 |

### Example 18

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Cinnamaldehyde | 10.00 |
| | Total | 100.00 |

### Example 19

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Benzaldehyde | 10.00 |
| | Total | 100.00 |

### Example 20

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | n-Undecanal | 10.00 |
| | Total | 100.00 |

### Example 21

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | n-Undecanol | 10.00 |
| | Total | 100.00 |

### Example 22

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Methyl Propanediol | 10.00 |
| | Total | 100.00 |

### Example 23

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Phenethyl alcohol | 10.00 |
| | Total | 100.00 |

### Example 24

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | glyceryl caprylate | 10.00 |
| | Total | 100.00 |

### Example 25

| S. No | Ingredients | wt. % |
|---|---|---|
| 1 | Water | 8.10 |
| 2 | Propylene Carbonate | 34.20 |
| 3 | 1,3 Propanediol | 9.00 |
| 4 | 1,2-Octanediol | 22.50 |
| 5 | 1,2 Hexanediol | 9.90 |
| 6 | 1,2 Decanediol | 6.30 |
| 7 | Glycerol Monolaurate | 10.00 |
| | Total | 100.00 |

### Example 26

| S. No | Ingredients | wt. % |
|---|---|---|
| 1 | Water | 9.00 |
| 2 | Propylene Carbonate | 35.00 |
| 3 | 1,3 Propanediol | 10.00 |
| 4 | 1,2-Octanediol | 23.00 |
| 5 | 1,2 Hexanediol | 11.00 |
| 6 | 1,2 Decanediol | 7.00 |
| 7 | Cetrimonium Chloride | 5.00 |
| | Total | 100.00 |

### Example 27

| S. No | Ingredients | wt. % |
|---|---|---|
| 1 | Water | 20.00 |
| 2 | Propylene Carbonate | 15.00 |
| 3 | 1,3 Propanediol | 15.00 |
| 4 | 1,2 Hexanediol | 20.00 |
| 5 | Glyceryl Mono/Di Caprylate; | 20.00 |
| | Propylene Mono/Di Caprylate | |
| 6 | 1,2 Decanediol | 10.00 |
| | Total | 100.00 |

### Example 28

| S. No | Ingredients | wt. % |
|---|---|---|
| 1 | PVP-K90 | 1.0 |
| 2 | Propylene Carbonate | 78.0 |
| 3 | 1,3 Propanediol | 5.0 |
| 4 | Benzoic acid | 8.0 |
| 5 | Dehydroacetic Acid | 8.0 |
| | Total | 100.0 |

### Example 29

| S. No. | Ingredients | wt % |
|---|---|---|
| 1 | Propylene Carbonate | 38.0 |
| 2 | 1,2 Octanediol | 25.0 |
| 3 | 1,2 Hexanediol | 11.0 |
| 4 | 1,3 Propanediol | 10.0 |
| 5 | Decanediol | 7.0 |
| 6 | Water | 9.0 |
| | Total | 100.0 |

### Example 30

| S. No. | Ingredients | wt. % |
|---|---|---|
| 1. | Water | 25.0 |
| 2. | Propylene Carbonate | 25.0 |
| 3. | Polyglycery-4-Laurate/Sebacate | 5.0 |
| | (and) Polyglyceryl-6, | |
| | Caprylate/Capriate (and) Water | |
| 4. | 1,2-Octanediol | 30.0 |
| 5. | 1,2-Decanediol | 15.0 |
| | Total | 100.00 |

### Example 31

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Capryl Hydroxamic Acid | 10.00 |
| | Total | 100.00 |

### Example 32

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | O-cymen-5-ol | 10.00 |
| | Total | 100.00 |

### Example 33

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | C-6 Alkyl Glycoside | 10.00 |
| | Total | 100.00 |

### Example 34

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | DL-Menthol | 10.00 |
| | Total | 100.00 |

### Example 35

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Propionic Acid | 10.00 |
| | Total | 100.00 |

### Example 36

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Phenethyl Alcohol | 10.00 |
| | Total | 100.00 |

### Example 37

| S. No. | Ingredients | wt. % |
|---|---|---|
| 1. | Water | 22.5 |
| 2. | Propylene Carbonate | 22.5 |
| 3. | Polyglycery-4-Laurate/Sebacate (and) | 4.50 |
| | Polyglyceryl-6, Caprylate/Capriate | |
| | (and) Water | |
| 4. | 1,2-Octanediol | 27.50 |
| 5. | 1,2-Decanediol | 13.50 |
| 6. | Sorbohydroxamic Acid | 10.00 |
| | Total | 100.00 |

### Example 38

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Benzohydroxamic Acid | 10.00 |
| | Total | 100.00 |

### Example 39

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Coco-Glucoside | 10.00 |
| | Total | 100.00 |

### Example 40

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Lauryl Glucoside | 10.00 |
| | Total | 100.00 |

### Example 41

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Decyl Glucoside | 10.00 |
| | Total | 100.00 |

### Example 42

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Piroctone Olamine | 10.00 |
| | Total | 100.00 |

### Example 43

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | 4-Allyl-2-(5-allyl-2-hydroxy-phenyl) | 10.00 |
| | Phenol | |
| | Total | 100.00 |

### Example 44

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Hexamidine Diisethionate | 10.00 |
| | Total | 100.00 |

### Example 45

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | 18β Glycyrrhetiric Acid | 10.00 |
| | Total | 100.00 |

### Example 46

| S. No. | Ingredients | wt. % |
|---|---|---|
| 1. | Water | 22.5 |
| 2. | Propylene Carbonate | 22.5 |
| 3. | Polyglycery-4-Laurate/Sebacate | 4.50 |
| | (and) Polyglyceryl-6, | |
| | Caprylate/Capriate (and) Water | |
| 4. | 1,2-Octanediol | 27.50 |
| 5. | 1,2-Decanediol | 13.50 |
| 6. | Glucono-Delta-Lactone | 10.00 |
| | Total | 100.00 |

### Example 47: Cumulative Synergistic Activity

The cumulative synergistic activity of propylene carbonate, organic compounds/preservative compounds are performed against selected microbial strains. The synergism of two-component compositions is demonstrated by testing a wide range of concentrations and ratios of compounds as follows.

Tryptic Soy Broth (TSB) media was used for bacterial evaluations and Yeast Malt Broth (YMB) for fungal evaluations. The compounds were added to the media and serially diluted. After serially diluting the media, 100 μl of a suspension of the testing bacteria or fungi were added to a final concentration of approximately 10^{6 -5} CFU/ml. The inoculated media was then incubated at 32° C. for 2-5 days for bacteria or at 28° C. for 3-7 days for fungi.

The lowest concentration of each compound or mixture or compounds to inhibit visible growth was taken as the minimum inhibitory concentration (MIC). The MIC was taken as end points of activity. End points for the mixture of compound A (Propylene Carbonate) and compound B (organic compounds/conventional preservative) were then compared with the end points for the pure active ingredient alone.

Synergism was determined by a commonly used and accepted method described by Kull A. C.; Eisman, P. C.; Sylwestrowicz, H. D. and Mayer, R. L. 1961. Applied Microbiology, 9:538-541 using the ratio determine by:

Qa/QA+Qb/QB=synergy

### Wherein:

QA is the concentration of compound A in PPM, acting alone, which produced an end point.
Qa is the concentration of compound A in PPM, in the mixture, which produced an end point.
QB is the concentration of compound B in PPM, acting alone, which produced an end point.
Qb is the concentration of compound B in PPM, in the mixture, which produced an end point

When the sum of Qa/QA+Qb/QB is greater than one, antagonism is indicated. When the sum is equal to one, additive is indicated. When the sum is less than one, synergism is demonstrated.

The experiments were performed to understand the cumulative synergistic effect between propylene carbonate, organic compounds and preservative compounds.

The results of cumulative synergism between propylene carbonate and organic compounds/preservative compounds are shown in Examples 48 through 64.

The results comprise following parameters: 1. Test organism (bacteria or fungi), 2. The end-point activity in % measured by MIC for the compound A alone (QA), for compound A in the mixture (Qa), for compound B alone (QB), for compound B in the mixture (Qb), 3. The ratio of Propylene carbonate or combinations of propylene carbonate and an organic compound (compound A) to organic compound (compound B) in that particular combination and the synergy index (SI) based on the formula SI=Qa/QA+Qb/QB.

### Example 48: Evaluation of Propylene Carbonate Vs. 1,2-hexanediol

| | | | | | | |
|---|---|---|---|---|---|---|
| | PC (A) | PC (a) | HD (B) | HD (b) | | |
| Microorganism | (%) | (%) | (%) | (%) | Ratio A:B | SI |

Bacteria:

| | | | | | | |
|---|---|---|---|---|---|---|
| E. coli (ATCC 8739) | 3.12 | 1.56 | 1.25 | 0.625 | 2.5:1 | 1 |
| S. aureus (ATCC 6538) | 12.5 | 6.25 | 2.5 | 1.25 | 5:01 | 1 |
| B. cepacia (ATCC 25416) | 3.12 | 1.56 | 0.625 | 0.312 | 5:01 | 1 |
| P. aeruginosa (ATCC 9027) | 3.12 | 0.78 | 1.25 | 0.625 | 2.5:1 | 0.75 |
| | 3.12 | 1.56 | 1.25 | 0.156 | 2.5:1 | 0.63 |

Fungi:

| | | | | | | |
|---|---|---|---|---|---|---|
| A. brasilensis (ATCC 16404) | 1.56 | 0.78 | 1.25 | 0.625 | 1.25:1 | 1 |

### Example 49: Evaluation of Propylene Carbonate Vs. 1,2 octanediol

| | | | | | | |
|---|---|---|---|---|---|---|
| | PC (A) | PC (a) | OD (B) | OD (b) | | |
| Microorganism | (%) | (%) | (%) | (%) | Ratio A:B | SI |

Bacteria:

| | | | | | | |
|---|---|---|---|---|---|---|
| E. coli (ATCC 8739) | — | — | — | — | — | — |
| S. aureus (ATCC 6538) | 3.12 | 1.56 | 0.625 | 0.312 | 5:1 | 1 |
| B. cepacia (ATCC 25416) | — | — | — | — | — | — |
| P. aeruginosa (ATCC 9027) | 3.12 | 1.56 | 0.625 | 0.312 | 5:1 | 1 |

Fungi:

| | | | | | | |
|---|---|---|---|---|---|---|
| A. brasilensis (ATCC 16404) | 1.56 | 0.39 | 0.312 | 0.156 | 5:1 | 0.75 |
| | 1.56 | 0.78 | 0.312 | 0.078 | 5:1 | 0.75 |

### Example 50: Evaluation of Propylene Carbonate+Octanediol (Ratio 4:1) Vs. Hexanediol

| | | | | | | |
|---|---|---|---|---|---|---|
| | PC/OD (A) | PC/OD (a) | HD (B) | HD (b) | Ratio | |
| Microorganism | (%) | (%) | (%) | (%) | A:B | SI |

Bacteria:

| | | | | | | |
|---|---|---|---|---|---|---|
| E. coli (ATCC 8739) | 1.25 | 0.625 | 1.25 | 0.313 | 1:1 | 0.75 |
| | 1.25 | 0.312 | 1.25 | 0.625 | 1:1 | 0.75 |
| S. aureus (ATCC 6538) | 1.25 | 0.625 | 2.5 | 0.625 | 1:2 | 0.75 |
| | 1.25 | 0.312 | 2.5 | 1.25 | 1:2 | 0.75 |
| B. cepacia (ATCC 25416) | 1.25 | 0.625 | 0.625 | 0.312 | 4:1 | 0.75 |
| | 1.25 | 0.312 | 0.625 | 0.312 | 4:1 | 0.75 |
| P. aeruginosa (ATCC 9027) | 2.5 | 1.25 | 1.25 | 0.312 | 2:1 | 0.75 |
| | 2.5 | 0.625 | 1.25 | 0.625 | 2:1 | 0.75 |

Fungi:

| | | | | | | |
|---|---|---|---|---|---|---|
| A. brasilensis (ATCC 16404) | 0.625 | 0.312 | 1.25 | 0.312 | 1:2 | 0.75 |
| | 0.625 | 0.156 | 1.25 | 0.626 | 1:2 | 0.75 |

### Example 51: Evaluation of Propylene Carbonate+Octanediol (Ratio 4:1) Vs Decanediol

| | | | | | | |
|---|---|---|---|---|---|---|
| | PC/OD | PC/OD | DD | DD | Ratio | |
| Microorganism | (A) (%) | (a) (%) | (B) (%) | (b) (%) | A:B | SI |

Bacteria:

| | | | | | | |
|---|---|---|---|---|---|---|
| E. coli | 1.25 | 0.625 | 0.0625 | 0.004 | 20:1 | 0.56 |
| (ATCC 8739) | 1.25 | 0.04 | 0.0625 | 0.031 | 20:1 | 0.53 |
| S. aureus | 1.25 | 0.312 | 0.0312 | 0.0156 | 40:1 | 0.75 |
| (ATCC 6538) | | | | | | |
| B. cepacia | 1.25 | 0.625 | 0.0625 | 0.0078 | 20:1 | 0.63 |
| (ATCC 25416) | 1.25 | 0.156 | 0.0625 | 0.0312 | 20:1 | 0.63 |
| P. aeruginosa | 2.5 | 1.25 | >2.5 | 0.031 | <1:1 | <0.51 |
| (ATCC 9027) | | | | | | |

Fungi:

| | | | | | | |
|---|---|---|---|---|---|---|
| A. brasilensis | 0.625 | 0.312 | 0.0156 | 0.0039 | 40:1 | 0.75 |
| (ATCC 16404) | 0.625 | 0.078 | 0.0156 | 0.0078 | 40:1 | 0.63 |

### Example 52: Evaluation of Propylene Carbonate+Hexanediol (Ratio 1.5:1) Vs Decanediol

| | | | | | | |
|---|---|---|---|---|---|---|
| | PC/HD | PC/HD | DD | DD | Ratio | |
| Microorganism | (A) (%) | (a) (%) | (B) (%) | (b) (%) | A:B | SI |

Bacteria:

| | | | | | | |
|---|---|---|---|---|---|---|
| E. coli | 2.5 | 1.25 | 0.0312 | 0.0156 | 80:1 | 1 |
| (ATCC 8739) | | | | | | |
| S. aureus | >2.5 | 2.5 | 0.0156 | 0.0078 | >160:1 | <1.0 |
| (ATCC 6538) | | | | | | |
| B. cepacia | 1.25 | 0.625 | 0.0625 | 0.0156 | 20:01 | 0.75 |
| (ATCC 25416) | 1.25 | 0.312 | 0.0625 | 0.0312 | 20:01 | 0.75 |
| P. aeruginosa | 2.5 | 1.25 | >2.5 | 0.0156 | <10:1 | >0.6 |
| (ATCC 9027) | | | | | | |

Fungi:

| | | | | | | |
|---|---|---|---|---|---|---|
| A. brasilensis | 2.5 | 1.25 | 0.0156 | 0.002 | 160:1 | 0.62 |
| (ATCC 16404) | 2.5 | 0.156 | 0.0156 | 0.0078 | 160:1 | 0.56 |

### Example 53: Evaluation of Propylene Carbonate Vs Hexylglycerine

| | | | | | | |
|---|---|---|---|---|---|---|
| | PC | PC | HG | HG | Ratio | |
| Microorganism | (A) (%) | (a) (%) | (B) (%) | (b) (%) | A:B | SI |

Fungi:

| | | | | | | |
|---|---|---|---|---|---|---|
| A. brasilensis | 3.12 | 1.56 | 0.156 | 0.039 | 20:1 | 1 |
| (ATCC 16404) | | | | | | |

### Example 54: Evaluation of Propylene Carbonate+Hexylglycerine (Ratio 5:1) Vs DD

| | | | | | | |
|---|---|---|---|---|---|---|
| | PC/HG | PC/HG | DD | DD | Ratio | |
| Microorganism | (A) (%) | (a) (%) | (B) (%) | (b) (%) | A:B | SI |

Fungi:

| | | | | | | |
|---|---|---|---|---|---|---|
| A. brasilensis | 1.9 | 0.95 | 0.008 | 0.0009 | 240:1 | 0.61 |
| (ATCC 16404) | 1.9 | 0.23 | 0.008 | 0.004 | 240:1 | 0.62 |

### Example 55: Evaluation of Propylene Carbonate+Cyclohexylglycerin (Ratio 1.5:1) Vs DD

| | | | | | | |
|---|---|---|---|---|---|---|
| | PC/CHG | PC/CHG | DD | DD | Ratio | |
| Microorganism | (A) (%) | (a) (%) | (B) (%) | (b) (%) | A:B | SI |

Fungi:

| | | | | | | |
|---|---|---|---|---|---|---|
| A. brasilensis | 2.5 | 0.625 | 0.0156 | 0.0078 | 160:1 | 0.75 |
| (ATCC 16404) | 2.5 | 1.25 | 0.0156 | 0.0009 | 160:1 | 0.55 |

### Example 56: Evaluation of Propylene Carbonate+Capryl Hydroxamic Acid

| | | | | | | |
|---|---|---|---|---|---|---|
| | PC | PC | CHA | CHA | Ratio | |
| Microorganism | (A) (%) | (a) (%) | (B) (%) | (b) (%) | A:B | SI |

Fungi:

| | | | | | | |
|---|---|---|---|---|---|---|
| A. brasilensis | 0.78 | 0.39 | 0.031 | 0.0075 | 25:1 | 0.75 |
| (ATCC 16404) | | | | | | |

Bacteria:

| | | | | | | |
|---|---|---|---|---|---|---|
| S. Aureus | 6.25 | 3.12 | 0.125 | 0.0625 | 50:1 | 1 |
| (ATCC#6538) | | | | | | |
| E. Coli | 1.56 | 0.78 | 0.031 | 0.0156 | 50:1 | 1 |
| (ATCC#8739) | | | | | | |

### Example 57: Evaluation of Propylene Carbonate+Undecanal (UND)

| | | | | | | |
|---|---|---|---|---|---|---|
| | PC | PC | UND | UND | Ratio | |
| Microorganism | (A) (%) | (a) (%) | (B) (%) | (b) (%) | A:B | SI |

Fungi:

| | | | | | | |
|---|---|---|---|---|---|---|
| A. brasilensis | 1.56 | 0.39 | 1.25 | 0.312 | 1.25:1 | 0.50 |
| (ATCC 16404) | | | | | | |

### Example 58: Evaluation of Propylene Carbonate+O-cymen-5-ol (DBL)

| | | | | | | |
|---|---|---|---|---|---|---|
| | PC | PC | DBL | DBL | Ratio | |
| Microorganism | (A) (%) | (a) (%) | (B) (%) | (b) (%) | A:B | SI |

Bacteria:

| | | | | | | |
|---|---|---|---|---|---|---|
| E. coli | 6.25 | 0.78 | 0.0625 | 0.3125 | 100:1 | 0.625 |
| (ATCC 8739) | | | | | | |

### Example 59: Evaluation of Propylene Carbonate+Alkyl Glucoside (AG6206)

| | | | | | | |
|---|---|---|---|---|---|---|
| | PC | PC | AG6206 | AG6206 | Ratio | |
| Microorganism | (A) (%) | (a) (%) | (B) (%) | (b) (%) | A:B | SI |

Bacteria:

| | | | | | | |
|---|---|---|---|---|---|---|
| P. aeruginosa | 3.12 | 1.56 | 3.12 | 0.39 | 1:1 | 0.625 |
| (ATCC 9027) | | | | | | |

### Example 60: Evaluation of Propylene Carbonate+DL-Menthol (DLM)

| | | | | | | |
|---|---|---|---|---|---|---|
| | PC | PC | DLM | DLM | Ratio | |
| Microorganism | (A) (%) | (a) (%) | (B) (%) | (b) (%) | A:B | SI |

Bacteria:

| | | | | | | |
|---|---|---|---|---|---|---|
| E. coli | 3.12 | 1.56 | 1.39 | 0.17 | 2.25:1 | 0.62 |
| (ATCC 8739) | | | | | | |
| S. aureus | 6.25 | 0.10 | 0.69 | 035 | 9:1 | 0.52 |
| (ATCC 6538) | | | | | | |
| B. cepacia | 1.56 | 0.78 | 0.69 | 0.17 | 2.25:1 | 0.75 |
| (ATCC 25416) | | | | | | |

### Example 61: Evaluation of Propylene Carbonate Vs. Propionic Acid (PA)

| | | | | | | |
|---|---|---|---|---|---|---|
| | PC | PC | PA | PA | Ratio | |
| Microorganism | (A) (%) | (a) (%) | (B) (%) | (b) (%) | A:B | SI |

Bacteria:

| | | | | | | |
|---|---|---|---|---|---|---|
| B. cepacia | 3.12 | 0.78 | 0.20 | 0.10 | 15.6:1 | 0.75 |
| (ATCC 25416) | | | | | | |

Fungi:

| | | | | | | |
|---|---|---|---|---|---|---|
| A. brasilensis | 3.12 | 1.56 | 0.078 | 0.01 | 40:1 | 0.62 |
| (ATCC 16404) | | | | | | |

### Example 62: Evaluation of Propylene Carbonate Vs. Phenethyl Alcohol (PhA)

| | | | | | | |
|---|---|---|---|---|---|---|
| | PC | PC | PhA | PhA | Ratio | |
| Microorganism | (A) (%) | (a) (%) | (B) (%) | (b) (%) | A:B | SI |

Bacteria:

| | | | | | | |
|---|---|---|---|---|---|---|
| B. cepacia | 3.12 | 1.56 | 0.156 | 0.02 | 20:1 | 0.62 |
| (ATCC 25416) | | | | | | |

Fungi:

| | | | | | | |
|---|---|---|---|---|---|---|
| C. albicans | 6.25 | 1.56 | 0.625 | 0.312 | 10:1 | 0.75 |
| (ATCC 10231) | | | | | | |

### Example 64: Evaluation of Propylene Carbonate Vs. o-Cymen-5-ol (DBL)

| | | | | | | |
|---|---|---|---|---|---|---|
| | PC | PC | DBL | DBL | Ratio | |
| Microorganism | (A) (%) | (a) (%) | (B) (%) | (b) (%) | A:B | SI |

Bacteria:

| | | | | | | |
|---|---|---|---|---|---|---|
| E. coli | 6.25 | 3.12 | 0.0625 | 0.0078 | 100:1 | 0.625 |
| ATCC# 8739 | 6.25 | 0.78 | 0.0625 | 0.031 | 100:1 | 0.625 |

### Example 65: Evaluation of Preservative Compositions in Commercial Prolipid Lamellar Composition

A standard Prolipid lamellar composition was engaged to test efficacy of the preservative composition of present application in Phase D at 1% by wt. or no preservative used to serve as control for the evaluation. The formulations employed for the evaluation test are disclosed in Examples 13, 14, 15, 28 and 29.

The results of efficacy test for the synergistic composition demonstrated that the composition is capable of killing gram positive and gram negative bacterial strains, yeast and fungi.

| INCI NAME | Ingredients | % w/w |
|---|---|---|
| Phase A | Water | 80 |
| | Disodium EDTA | 0.05 |
| | Triethanolamine 99% | 0.05 |
| | 2-Propenic Acid, polymer with 1-ethylenyl- | 0.5 |
| | 2-pyrolidinone and 3-(2-propenyloxy)-2,2- | |
| | bis(2-propenyloxy)methyl)-1-propanol | |
| | Glycerin | 5 |
| Phase B | Glyceryl Stearate (and) Behenyl Alcohol (and) | 4.5 |
| | Palmitic Acid (and) Stearic Acid (and) Lecithin | |
| | (and) Lauryl Alcohol (and) Myristyl Alcohol | |
| | (and) Cetyl Alcohol | |
| | Myristyl Myristate (and) | 4 |
| | Myristyl Laurate | 2 |
| | Dimethicone | 3 |
| | Glyceral Dilaurate | 1 |
| Phase C | Vital-ET | 1.5 |
| | Triethanolamine 99% | 0.15 |
| Phase D | Preservative | 1 |
| | Total | 100 |

The prolipid lamellar composition were evaluated with preservative compositions of Examples 13, 14, 15, or 28 at 1% or no preservative (control) for the challenge test against several microorganisms following a 28 day double inoculation tests, where the samples were inoculated with either Gram positive bacteria (Staphylococcus aureus 6538), a composite of Gram negative bacteria (Escherichia coli 8739, Pseudomonas aeruginosa 9027 and Burkholderia cepacia 25416), whereas the bacteria is inoculated at day 0 and day 21 to a final concentration of about 10̂6-7 cfu/ml and the fungal composite is inoculated at day 0 and day 21 to a final concentration of about 10̂5-6 spores/ml. The inoculated samples were plated at days 2, 7, 14, 21 and 28. The recovery media is Letheen Agar for bacteria and Potato Dextrose agar for fungi. The microorganisms recovered at each time interval are shown in the following Table 1.

TABLE 1
Preservative Evaluation Test of Proplipid lamellar composition

| Treatment | Microbial strains | Day 2 | Day 7 | Day 14 | Day 21 | Day 28 |
|---|---|---|---|---|---|---|
| No preservative | Gram (+) bacteria | 3.6E\hat{ }6 | >1E4 | 9.8E3 | 5.0E3 | >1E4 |
| (Control) | Gram (−) bacteria | >1E6 | >1E4 | >1E4 | >1E4 | >1E4 |
| | Yeast and mold | 1.3E\hat{ }6 | >1E4 | >1E4 | >1E4 | >1E4 |
| Example 14 at 1% | Gram (+) bacteria | <10 | <10 | <10 | <10 | <10 |
| | Gram (−) bacteria | <10 | <10 | <10 | <10 | <10 |
| | Yeast and mold | 1.0E\hat{ }5 | 3.7E4 | 4.7E4 | >1E4 | 1.8E5 |
| Example 13 at 1% | Gram (+) bacteria | <10 | <10 | <10 | <10 | <10 |
| | Gram (−) bacteria | <10 | <10 | <10 | <10 | <10 |
| | Yeast and mold | 1.2E\hat{ }4 | <10 | <10 | <10 | <10 |
| Example 15 at 1% | Gram (+) bacteria | <10 | <10 | <10 | <10 | <10 |
| | Gram (−) bacteria | <10 | <10 | <10 | <10 | <10 |
| | Yeast and mold | 4.7E\hat{ }4 | 1.7E4 | 1.4E3 | 1.0E2 | 1.4E4 |
| Example 28 at 1% | Gram (+) bacteria | 1.8E3 | <10 | <10 | <10 | <10 |
| | Gram (−) bacteria | 1.2E3 | <10 | <10 | <10 | <10 |
| | Yeast and mold | 1.6E3 | 1.2E2 | 6.0E1 | 1.0E1 | 3.0E1 |

As shown in the Table 1, the prolipid lamellar composition containing formulations of Examples 13, 14, 15 or 28 at 1% by wt., have significantly reduced the levels of inoculated bacteria and inhibited their growth. Furthermore, the Prolipid lamellar compositions containing compositions of Examples 13 or 28 were also found to be very effective in controlling yeast and mold growth, wherein the unpreserved control sample was susceptible to significant microbial growth.

### Example 66: Evaluation of Baby Wipe Juice Composition

A standard Baby juice composition as described below was prepared, and wherein, a preservative composition of Example 29 was incorporated as phase D at 1.5% by wt. or no preservative to serve as a control.

| INCI NAME | Ingredients | % w/w |
|---|---|---|
| Phase A | DI Water | 97.9 |
| | Citric Acid 10% aq. | 0.5 |
| Phase B | Tween 20 (Liposorb 20) | 0.2 |
| | Vitamin E (Vital ET) | 0.05 |
| | Fragrance (Petal Avalanch) | 0.05 |
| Phase C | Si Tec DMC 6031 | 0.1 |
| | Glycerine | 0.5 |
| Phase D | NaOH 10% aq. (adjust pH) | 0.2 |
| | Preservative | 0.5 |
| | Total | 100 |

The Baby Juice composition containing composition of Example 29 at 1.5% or no preservative (control) in a cellulosic wipe were then challenged with microorganisms following a 21 day inoculation tests, where the samples were inoculated with either Gram positive bacteria (Staphylococcus aureus 6538), a composite of Gram negative bacteria (Escherichia coli 8739, Pseudomonas aeruginosa 9027 and Burkholderia cepacia 25416), whereas the bacteria is inoculated at day 0 to a final concentration of about 10̂6-7 cfu/ml and the fungal composite is inoculated at day 0 to a final concentration of about 10̂5-6 spores/ml. The inoculated samples are plated at days 7, 14 and 21. The recovery media is Letheen Agar for bacteria and Potato Dextrose agar for fungi. The microorganisms recovered at each time interval are shown in the following Table 2. The Baby Juice composition containing composition of Example 29 at 1% or no preservative (control) in a cellulosic wipe were then challenged with microorganisms following a 21 day inoculation tests, where the samples are inoculated with either Gram positive bacteria (Staphylococcus aureus 6538), a composite of Gram negative bacteria (Escherichia coli 8739, Pseudomonas aeruginosa 9027 and Burkholderia cepacia 25416), whereas the bacteria is inoculated at day 0 to a final concentration of about 10̂6-7 cfu/ml and the fungal composite is inoculated at day 0 to a final concentration of about 10̂5-6 spores/ml. The inoculated samples are plated at days 7, 14 and 21. The recovery media is Letheen Agar for bacteria and Potato Dextrose agar for fungi. The microorganisms recovered at each time interval are shown in the following Table 2.

TABLE 2
Preservative Evaluation Test of Baby Wipe Juice composition

| Treatment | Microbial strains | Day 7 | Day 14 | Day 21 |
|---|---|---|---|---|
| Control/No | Gram pos. bacteria | 3.7E\hat{ }5 | NA | NA |
| preservative | Gram neg. bacteria | 7.7E\hat{ }6 | 1.7E\hat{ }7 | 3.4E\hat{ }7 |
| | Yeast and mold | 1.2E\hat{ }5 | 5.5E\hat{ }4 | 5E\hat{ }4 |
| Example 29 | Gram pos. bacteria | <10 | <10 | <10 |
| at 1% wt. | Gram neg. bacteria | 1E\hat{ }1 | <10 | <10 |
| | Yeast and mold | 1.2E\hat{ }2 | <10 | <10 |

As shown in the Table 2, the Baby wipe composition containing composition of example 29 at 1% by wt. has significantly reduced the levels of inoculated bacteria, yeast and mold and prevented their growth. The unpreserved control sample was susceptible to significant microbial growth.

Shake Flask Method Test

| Sample Description | 24 hours | LOG | LR | 48 hours | Log | LR | Dilution |
|---|---|---|---|---|---|---|---|
| — | 1.20E+09 | 9.1 | n/a | 1.10E+09 | 9.0 | n/a | |
| 90% Blend 100 and 10% glucolactone | 2.00E+02 | 2.3 | 6.8 | 4.50E+03 | 3.7 | 5.4 | 1% |
| 50% Blend 100, 30% water and | 1.20E+03 | 3.1 | 6.0 | <10 | <1 | >8 | 1% |
| 20% glucono lactone | | | | | | | |
| Blend 100 90% and 10% hydroxamic acid | <10 | <1 | >8 | <10 | <1 | >8 | 1% |
| 60% Blend 100, 10% hydroxamic acid, | 1.00E+01 | <1 | >8 | <10 | <1 | >8 | 1% |
| 10% glucono lactone, 20% water | | | | | | | |
| 90% blend 100, 5% hydroxamic acid and | 1.00E+01 | <1 | >8 | <10 | <1 | >8 | 1% |
| 5% glucono lactone | | | | | | | |
| Propylene carbonate 30%, octanediol 30%, | <10 | <1 | >8 | <10 | <1 | >8 | 1% |
| Hydroxamic acid 5%, glucono lactone 10%, | | | | | | | |
| water 25% | | | | | | | |
| Blend 100 | <10 | <1 | >8 | <10 | <1 | >8 | 1% |
| Propylene carbonate 30%, water 20%, | <10 | <1 | >8 | <10 | <1 | >8 | 1% |
| octanediol 30% hyroxamic acid 10%, | | | | | | | |
| gluono lactone 10% | | | | | | | |

*MEDIA Tested with bacterial composition - TSB pH 7

| Sample Description | 48 hours | Log | LR | 7 Days | Log | LR | Dilution |
|---|---|---|---|---|---|---|---|
| — | 2.00E+08 | 8.3 | n/a | 2.00E+09 | 9.3 | n/a | — |
| 90% Blend 100 and 10% glucolactone | 1.00E+01 | 1.0 | 8.0 | <10 | <1 | >8 | 1% |
| 50% Blend 100, 30% water and | 4.00E+01 | <1 | >8 | <10 | <1 | >8 | 1% |
| 20% glucono lactone | | | | | | | |
| Blend 100 90% and 10% hydroxamic acid | <10 | <1 | >8 | <10 | <1 | >8 | 1% |
| 60% Blend 100, 10% hydroxamic acid, | <10 | <1 | >8 | <10 | <1 | >8 | 1% |
| 10% glucono lactone, 20% water | | | | | | | |
| 90% blend 100, 5% hydroxamic acid and | <10 | <1 | >8 | <10 | <1 | >8 | 1% |
| 5% glucono lactone | | | | | | | |
| Propylene carbonate 30%, octanediol 30%, | <10 | <1 | >8 | <10 | <1 | >8 | 1% |
| Hydroxamic acid 5%, glucono lactone 10%, | | | | | | | |
| water 25% | | | | | | | |
| Blend 100 | <10 | <1 | >8 | <10 | <1 | >8 | 1% |
| Propylene carbonate 30%, water 20%, | <10 | <1 | >8 | <10 | <1 | >8 | 1% |
| octanediol 30% hyroxamic acid 10%, | | | | | | | |
| gluono lactone 10% | | | | | | | |

*MEDIA Tested with mold composition - TSB pH 7

While this invention has been described in detail with reference to certain preferred embodiments, it should be appreciated that the present invention is not limited to those precise embodiments. Rather, in view of the present disclosure, many modifications and variations would present themselves to those skilled in the art without departing from the scope and spirit of this invention.

What is claimed is:

1. A synergistic preservative composition capable of providing broad spectrum antimicrobial activity comprising:
i. about 0.1 wt. % to about 99.9 wt. % of propylene carbonate;
ii. about 0.1 wt. % to about 99.9 wt. % of one or more organic compounds, and wherein, inclusion of each additional organic compound is capable of demonstrating cumulative synergistic effect; and
iii. optionally about 0.1 wt. % to 99.0 wt. % of one or more preservative compounds, and wherein, inclusion of each preservative compound is capable of demonstrating cumulative synergistic effect,
wherein the Synergy Index (SI) value of the total composition is from about 0.05 to about 1.0.

2. The preservative composition according to claim 1, wherein the synergy index (SI) values of the composition is from about 0.05 to 0.96.

3. The preservative composition according to claim 1, wherein said cumulative synergy increases the efficacy of the total composition and reduces the required antimicrobial use levels of said (i) one or more organic compounds and/or (ii) one or more preservative compounds.

4. The preservative composition according to claim 1, wherein the inclusion of propylene carbonate to a said (i) one or more organic compound/s and/or (ii) one or more preservative compound/s provides an effective composition capable of demonstrating cumulative synergism.

5. The preservative composition according to claim 1, wherein said (i) one or more organic compound/s and/or (ii) one or more preservative compound/s are selected based on their Synergy Index ranging from about 0.10 to about 0.96 to provide cumulative synergy.

6. The preservative composition accordingly claim 1, wherein said organic compounds are selected from the group consisting of diols, C₂-C₂₀ alkane diols, glycerins, C₄-C₁₈ alkyl glycerins, esters of glycerins, organic acids and their sodium/potassium salts, C₂-C₂₀ fatty acids and their sodium/potassium salts, esters of organic acids, esters of C₂-C₂₀ fatty acids, waxes, terpenes, triglycerides, protein acids, amino peptides, oligo peptides, aromatic aldehydes, glucosides, enzymes, peptides/amino acid and their esters, essential oils, natural preservatives, herbal preservatives, and/or oils derived from natural products.

7. The preservative composition according to claim 6, wherein the organic acid is selected from the group consisting of sugar acids, α-hydroxy carboxylic acids, β-hydroxy carboxylic acids, α-hydroxy organic acids and/or β-hydroxy organic acids.

8. The preservative composition according to claim 6, wherein the fatty acid is selected from the group consisting of saturated fatty acids, or unsaturated fatty acids.

9. The preservative composition according to claim 1, wherein said synergistic preservative composition is selected from the group consisting of:
i. (a) propylene carbonate with (b) octanediol/decanediol/hexanediol;
ii. (a) propylene carbonate with (b) hexylglycerin/cyclohexyl glycerin;
iii. (a) a mixture of propylene carbonate and hexylglycerin/cyclohexyl glycerin with (b) octanediol/decanediol/hexanediol;
iv. (a) a mixture of propylene carbonate and octanediol/decanediol/hexanediol with (b) hexylglycerin/cyclohexyl glycerins;
v. (a) a mixture of propylene carbonate, octanediol, decanediol, water, salicylaldehyde, and undecanal; and
vi. (a) a mixture of propylene carbonate and cyclohexylglycerin/hexanediol/octanediol with (b) sorbic acid and their alkali metal salts, salicylic acid and their alkali metal salts, or octanoic acid and their alkali metal salts.

10. The preservative composition according to claim 1, wherein said preservative or preservative system comprises at least one preservative compound selected from the group consisting of triclosan, 2-methyl-4-isothiazolin-3-one (MIT), 1,2-benzisothiazolin-3-one (BIT), 5-chloro-2-methyl-4-isothiazolin-3-one (CMIT), 2-octyl-4-isothiazolin-3-one (OIT), 3-iodo-2-propynylbutyl-carbamate (IPBC), 3-iodopropynyl-N-phenyl carbamate (IPPC), zinc pyrithione (ZnPy), bronopol, quaternary ammonium compounds, parabens, alkyl parabens, chlorophenisin, benzyl alcohol, organic acids, sorbic acid and their salts, benzoic acid and their salts, salicylic and their salts, potassium sorbate, sodium benzoate, phenoxyethanol, diazolidinyl urea, imidazolidinyl urea, sodium hydroxymethyl glycinate, hydantoins, sodium pyrithione, phenyl ethanol, phenyl propanol, benzalkonium quaternary ammonium compounds, fatty acids and their salts, α-hydroxy acids and their salts, beta acids and their salts, glycerols, hexyl glycerine, tropolones, sisquiterpenes, and/or ethyl hexyl glycerine.

11. The preservative composition according to claim 1, wherein said composition is capable of inhibiting or killing yeasts, mold spores, gram (+), gram (−) bacterial strains, acne causing strains, odor causing strains, or mycoses causing strains.

12. The preservative composition according to claim 1, wherein said composition is capable of inhibiting or killing Candida tropicalis, Candida albicans, Hansenula anomala, Saccharomyces cerevisiae, Torulaspora delbreuckii, Zygosaccharomyces bailii, Zygosaccharomyces rouxii, Bacillus subtilis, Bacillus cereus, Staphylococcus aureus, Staphylococus epidermidis, Escherichia coli, Salmonella typhimurium, Salmonella enteritidis, Pseudomonas aeruginosa, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, Aspergillus brasiliensis, Burkhodelia cepacia, Enterobacter aerogenes, Enterobacter cloacae, Enterobacter gergoviae, Klebsiella pneumoniae, Proteus vulgaris, Pseudomonas fluorescens, Pseudomonas putida, Penicillium pinophilum and/or Mucor racemosus.

13. The preservative composition according to claim 1, wherein said composition is stable on storage for at least 2 years at room temperature.

14. The preservative composition according to claim 1, wherein said composition is aqueous or non-aqueous in nature.

15. The preservative composition according to claim 1, wherein said composition is delivered as an emulsion, microemulsion, nanoemulsion, solution, dispersion, suspension, complex coacervate, lamellar based delivery system, liposome/niosome formulation, or concentrate.

16. The preservative composition according to claim 1 employed in aqueous and non-aqueous based end-user applications comprising cosmetic products, toiletry products, personal care products, oral care products, skin care products, hair care products, household & cleaning products, soap and bath products, industrial and institutional cleaning products, disinfecting products, wound care, sanitary products, agricultural compositions, textile industries, coating industries and/or laundry products.

17. The preservative composition according to claim 1, wherein the amount of preservative composition employed in aqueous and non-aqueous based end-user products/compositions is in the range of from about 0.01 wt. % to about 5.0 wt. % of the total composition.

18. A process for preparing the synergistic preservative composition of claim 1, wherein said process comprises mixing (i) about 0.1 wt. % to about 99.9 wt. % of propylene carbonate; (ii) about 0.1 wt. % to about 99.9 wt. % of one or more organic compounds selected from the group consisting of diols, C₂-C₂₀ alkane diols, glycerins, C₄-C₁₈ alkyl glycerins, esters of glycerins, organic acids and their sodium/potassium salts, C₂-C₂₀ fatty acids and their sodium/potassium salts, esters of organic acids, esters of C₂-C₂₀ fatty acids, waxes, terpenes, triglycerides, amino acids, protein acids, amino peptides, oligo peptides, essential oils, natural preservatives, herbal preservatives, and/or oils derived from natural products; and (iii) optionally about 0.1 wt. % to 99.0 wt. % of one or more preservatives to provide homogenous solution.

19. A synergistic preservative composition capable of providing broad spectrum antimicrobial activity comprising:
i. about 0.1 wt. % to about 99.9 wt. % of propylene carbonate;
ii. about 0.1 wt. % to about 99.9 wt. % of one or more organic compounds selected from the group consisting of diols, alkane diols, glycerins, alkyl glycerins, esters of glycerins, organic acids and their salts, fatty acids and their salts, and/or esters of long chain fatty acids; and
iii. optionally about 0.1 wt. % to 20.0 wt. % of one or more preservatives.

20. A synergistic preservative composition capable of providing broad spectrum antimicrobial activity comprising:
i. about 0.1 wt. % to about 99.9 wt. % of propylene carbonate;
ii. about 0.1 wt. % to about 99.9 wt. % of one or more organic compounds selected from the group consisting of propanediol, hexanediol, octanediol, decanediol, hexylglycerin, cyclohexylglycerin, glyceryl mono-di caprylate, propylene mono-di caprylate, octanoic acid and its sodium salts, methyl propane diol, glyceryl caprylate, propylene glycol monoheptanoate, glycerol monolaurate; and
iii. optionally about 0.1 wt. % to 20.0 wt. % of one or more preservative is selected from the group consisting of salicylic acid, sodium salicylate, sorbic acid, potassium sorbate, dehydroacetic acid (DHA), benzoic acid, sodium benzoate, cinnamaldehyde, benzaldehyde, n-undecanol, and/or cetrimonium chloride.

21. A cosmetic or personal care or house hold, cleaning, Industrial & Institutional product comprising synergistic preservative composition of claim 1, and wherein, the amount of said preservative composition is in the range of from about 0.01 wt. % to 5.0 wt. %, relative to the total mass of said products.

22. A method of killing bacteria, fungi, molds, yeasts and viruses or inhibiting their growth in a cosmetic, personal care, house hold, cleaning, and/or Industrial & Institutional products susceptible to growth of microorganisms comprising incorporating into said products about 0.01 wt. % to 5.0 wt. % of the preservative composition of claim 1.
